(19) United States
(12) Patent Application Publication
(10) Pub. No.: US 2020/0025100 A1
(43) Pub. Date: Jan. 23, 2020

(54) ACCESSORY RELAY FOR GAS TURBINE ENGINE

(71) Applicant: SAFRAN TRANSMISSION SYSTEMS, Colombes (FR)

(72) Inventor: Boris Pierre Marcel MORELLI, Moissy-Cramayel (FR)

(21) Appl. No.: 16/496,897

(22) PCT Filed: Mar. 16, 2018
(86) PCT No.: PCT/FR2018/050642

§ 371 Date: Sep. 23, 2019

(30) Foreign Application Priority Data
Mar. 27, 2017 (FR) 1752530

(51) Int. Cl. F02C 7/32

(52) U.S. Cl. CPC F02C 7/32; F05D 2220/323

(57) ABSTRACT

Accessory relay (100) suitable for driving accessory equipment for a gas turbine engine, such as an aircraft engine, comprising a housing (101) and a plurality of gear wheels (110) inside the housing, the wheels each comprising a tubular body (110a) and an outer annular web (110b) comprising outer peripheral teeth (110c), the wheels being supported in the housing by bearings (120), at least one (110) of said gear wheels being supported by a single bearing (120), characterized in that this bearing (120) comprises a fixed outer ring (122) that is radially further out with respect to an axis A of rotation of the wheel and is mounted in a bore (105) of the housing, and a mobile inner ring (123) that is radially further in with respect to the axis A and is mounted on the body of the wheel, said bearing being spaced apart passing through the inner periphery of the web of this wheel.

### FIELD OF THE INVENTION

The field of this invention is that of turbomachines, in particular gas turbine engines for aircraft propulsion. The invention concerns the drive housings for the accessory equipment associated with these turbomachines, generally known as accessory relay or accessory gear box and its acronym AGB.

### BACKGROUND ART

The background includes in particular patent applications published under the numbers WO-A2-2011/148078 and FR-A1-3 009 045.

Part of the energy generated by the engine is used to drive different engine equipment. The required power is taken mechanically, generally from the shaft of the high-pressure body of the gas turbine engine, by a power take-off shaft that is connected to the drum of the input pinion in the accessory relay. The relay is mounted on the engine casing and includes several equipment or accessories that it supports, such as an electric generator, alternator, hydraulic fuel and oil pumps, starter, etc.

The relay consists of an elongated housing inside which gear wheels are mounted to form a gear train that drives the equipment. These wheels include a drum or tubular body that can be connected to the drive shaft of an equipment. One of the wheels is also connected to the input shaft of the relay. The various devices driven by the relay are mounted directly on the housing, and the associated drives pass through the wall of the housing through appropriate openings. The wheels constituting the gear train inside the housing are generally parallel axes. According to the prior art known to this applicant, the drums of the pinions are supported on one side by the wall of the housing which is opposite to that which includes the opening through which the equipment is driven, and on the other side by the wall including the opening or a cover attached to the wall. As a general rule, the drum of the pinions of the gear wheel is carried on the one hand by the outer ring of a roller or ball bearing fixed on the uncut bottom wall of the housing and on the other hand by the outer ring of a ball or roller bearing fixed on the cover associated with the accessory. For its part, the meshing gear teeth of the gear wheel are located between the two bearings.

This applicant has already proposed improvements for this type of accessory relay, described for example in applications WO-A1-2012/175884 or EP-A1-1 898 072.

Such an arrangement has a certain dimension in the direction of the gear axes. As part of the continuous improvement of its products, the present applicant wishes to reduce the dimension in said direction. It should be noted that roller bearings have a misalignment capability that imposes a minimum centre distance, which limits the possibility of reducing the thickness of the relays. Unless the misalignment capacities of the rollers are increased and their load capacity reduced, a different solution to the assembly must be found. This is the objective set by the present applicant who filed the patent application FR-A1-3 018 860.

Application FR-A1-3 018 860 describes an accessory relay in which a gear wheel is supported by a single roller bearing. The gear wheel comprises a web provided with a gear teeth on its periphery, the web being arranged mainly in the median plane of the roller bearing. The roller bearing comprises a radially inner fixed ring mounted on an axis integral with the housing and a movable ring integral with the wheel.

However, the diameter of the roller bearing is limited by the diameter of the gear teeth. Indeed, since the gear teeth extends around the roller bearing (whose movable ring is connected to the gear teeth by the web of the wheel), the bearing cannot have a diameter equal to or greater than that of the gear teeth.

In addition, the radial dimension of the web, between its inner and outer periphery, is low with this solution, which results in a high stiffness of the web and the wheel.

This invention proposes an improvement to this technology, which is simple, efficient and economical.

### SUMMARY OF THE INVENTION

In accordance with the invention, this objective is achieved with an accessory relay suitable for driving accessory equipment of a gas turbine engine, such as an aircraft engine, comprising a housing and a plurality of gear wheels inside the housing, the housing including means for fixing the accessory equipment to the housing and for driving it by the gear wheels through openings in the housing, the wheels each comprising a tubular body and an outer annular web comprising an outer peripheral gear teeth, the wheels being supported in the housing by bearings, at least one of said gear wheels being supported by a single bearing, characterized in that this bearing comprises a fixed ring radially outer with respect to an axis A of rotation of the wheel and mounted in a bore of the housing, and a movable ring radially inner with respect to axis A and mounted on the body of the wheel, said bearing being spaced apart axially from a plane perpendicular to the axis A of the wheel and passing through the inner periphery of the web of this wheel.

The bearing, preferably with rolling element, is preferably suitable for taking moments perpendicular to the axis of rotation of the gear wheel as well as axial and radial loads.

Thanks to the use of a roller bearing with this property, the relay operates properly while reducing its thickness because the assembly of the wheels is more compact and is no longer required by a minimum centre distance. In addition, the diameter of the roller bearing is not limited by the diameter of the gear teeth, which is advantageous. In addition, the radial dimension of the web is not limited by the positioning of the roller bearing and can have various shapes to optimize its rigidity.

The accessory relay according to the invention may include one or more of the following characteristics, taken in isolation from each other, or in combination with each other:
the bearing is of the rolling element type and for example with double row of balls and angular contact; alternatively, it can be a sliding bearing, a roller bearing, a double tapered bearing, etc.,
the bearing for guiding the wheel is located on the side opposite the opening of the housing aligned with the axis A of this wheel,
the body is provided with inner splines; alternatively, the body may not have any splines,
said splines are traversed by said plane; alternatively, they could be axially displaced with respect to this plane,
the outer ring includes an outer annular flange applied and fixed by means of fixing means on the housing,
the outer ring comprises an inner annular flange applied and fixed by means of fixing means to the housing,
said plane passes through the outer gear teeth of the web; alternatively, this plane could be axially displaced from this gear teeth,
the web has a non-planar shape; it can of course also have a flat shape.

The present invention also concerns a turbomachine equipped with an accessory relay as described above.

### BRIEF DESCRIPTION OF THE FIGURES

Other characteristics and advantages will emerge from the following description of a non-limiting embodiment of the invention with reference to attached drawings on which:

FIG. 1 shows a partial axial cross-section view of an accessory relay of the prior art,

FIG. 2 shows an axial cross-sectional view of a part of an accessory relay according to the invention,

FIGS. 3a to 3f show axial cross-sectional views of variants of embodiments of accessory relay according to the invention.

### DETAILED DESCRIPTION OF AN EMBODIMENT OF THE INVENTION

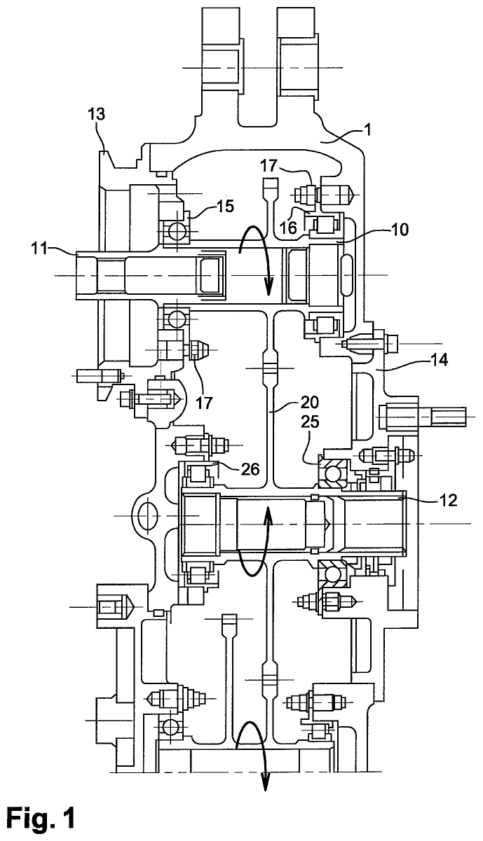

FIG. 1 shows in cross-section one end of an accessory relay of a turbomachine according to the prior art. It consists of a housing, generally from a foundry and then reworked with machining, in which gears are mounted to receive the pinions or gear wheels used to drive one of the accessories attached to the accessory relay. In the figure are shown two gear wheels, the first 10 is attached to the input shaft 11 in the AGB and the second 20 has inner splines 12 for driving an accessory.

Once the gear wheels are in place in the housing 1, the openings through which the accessory drive axes pass are closed by covers to ensure that the assembly is sealed and to ensure that one of the bearings on the gear wheel shaft is carried. In the case of the first gear 10, a cover 13 closes the opening on the side of the input shaft 11. For the gear wheel 20, a cover 14 closes the opening through which the first drive shaft 12 passes.

It can be seen on the gears that they are carried by bearings: a ball bearing held in place by the cover closing the opening allowing the passage of the corresponding drive shaft and a roller bearing which is fixed on the corresponding bottom wall of the housing 1, i.e. the wall opposite to the one in which the passage opening of the corresponding shaft is made.

The outer ring 15 of the ball bearing of the first gearbox 10 is thus fixed on the input shaft cover 13 by means of stud-nut type means while the outer ring 16 of the roller bearing of the same first gearbox is fixed directly on the bottom of the housing 1, again by stud-nut type means of assembly 17. The same applies to the second gear, whose outer ring 25 of its ball bearing is fixed on the first accessory drive cover 14 while that 26 of its roller bearing is fixed on the corresponding bottom of the housing 1.

According to this prior art, the gear wheels are thus placed between the two bearings by which the shaft is supported. This arrangement distributes the load between the bearings but requires a minimum distance between the two bearings and is sensitive to misalignment between the centering diameters of the cover and casing bearings. In other cases of application the lines can use a roller bearing assembly/roller bearing.

However, this arrangement requires a minimum distance between the walls of housing to accommodate the wheel and the two roller bearings on either side of the wheel.

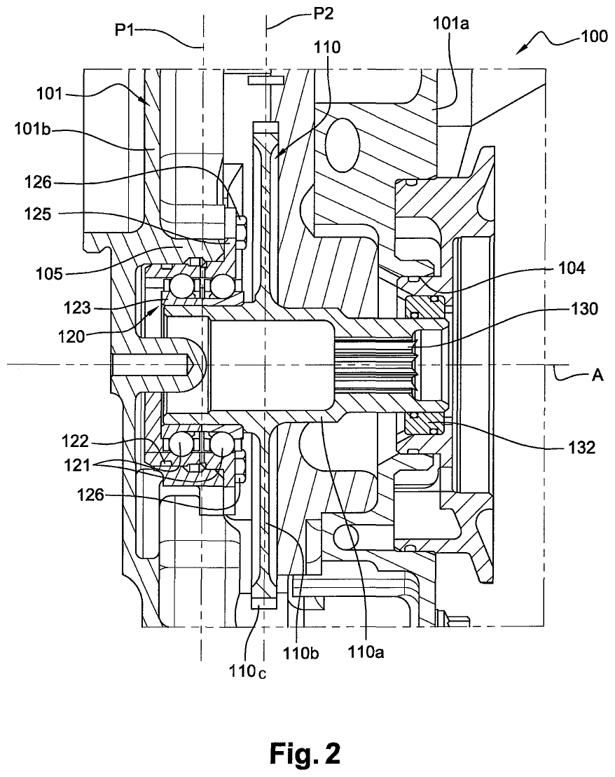

FIG. 2 shows an accessory relay in accordance with the invention.

The housing 101 of the accessory relay 100 according to the invention, of which only a part can be seen at a gear wheel 110, comprises two parallel walls 101a and 101b spaced apart for the accommodating of the wheel 110. A wall 101a is provided with an opening 104 through which the wheel 110 can be accessed. A bore 105 is provided in the bottom wall 101b, on the side opposite the opening 104 of the other wall 101a and opposite it.

The gear wheel 110 is rotatably mounted in bore 105 by means of a roller bearing 120 with double ball raw and angular contact, comprising an outer ring 122 and an inner ring 123 between which the double row of balls 121 is arranged.

The outer ring 122 is, for example, in one piece. According to this embodiment, it comprises a central part and two lateral parts forming two inner rolling races. These races are made in the form of rolling grooves, rotation around the axis of the bearing and oriented substantially back to back. The grooves have a radial arc-shaped cross-section with their concavity radially towards the bearing axis A and axially each laterally towards the outside of the bearing on the side of the corresponding lateral part. Alternatively, the bearing could be double and tapered.

The outer ring 122 here comprises at one axial end an outer annular flange 125 which extends radially outwards and which is applied axially against the free circumferential edge of the bore 105. This flange 125 includes axial holes for the passage of screws 126 for fixing the bearing to the housing 101.

The inner ring 123 here comprises two inner half-rings, arranged side by side and axially pre-loaded against each other during operation. Each of the inner half-rings has an outer rolling race. The half-rings are symmetrical in relation to a median transverse plane. The two half-rings are pre-loaded axially against each other when the bearing is mounted in the operating configuration. The outer rolling races have the shape of rolling groove which also rotate around the axis of the bearing. They have a radial arc-shaped cross-section and the concavity of each is turned radially outwards from the bearing and axially towards the outer rolling race of the other inner half-ring. The outer rolling race of the inner ring 123 are thus substantially arranged face-to-face.

The balls 121 in one row are mounted in rolling contact between the outer rolling groove of a first inner half ring and the inner rolling groove facing the outer ring 122, while the balls 121 in the other row are mounted in rolling contact between the outer rolling groove of the second inner half ring and the inner rolling groove facing the outer ring 122.

The balls 121 are thus mounted with angular contact, with respect to the median plane of the bearing and which corresponds to the axial contact plane of the inner half-rings, when the bearing is axially pre-loaded during assembly, in the operating configuration. If necessary, ball cages are provided between the two rings to hold the balls between the rolling races.

In the example shown, the median plane P1 of symmetry of the double-row ball bearing is axially spaced from the plane P2 of the wheel 110C of the wall 110, which is perpendicular to axis A and passes through the inner periphery of the web of the wall 110.

The wheel 110 essentially comprises a tubular body 110a with an axis A and the web 110b which extends radially outwards from the body and carries a meshing gear teeth 110c on its periphery. The web 110b is here flat and therefore extends completely in the plane P2.

The web 110C is placed substantially in the middle of the body 110a, along its axial dimension.

The portion of the body 110a, opposite the opening 104, is at least partially engaged in the bore 105 and guided in it by the bearing 105, whose inner ring 123 is therefore mounted directly on the body.

The portion of the body 110a, located on the side of the opening 104, includes inner splines 130 for the rotational attachment of the wheel to a shaft of an equipment or accessory. This portion is surrounded by a sealing ring 132 mounted in the opening 104.

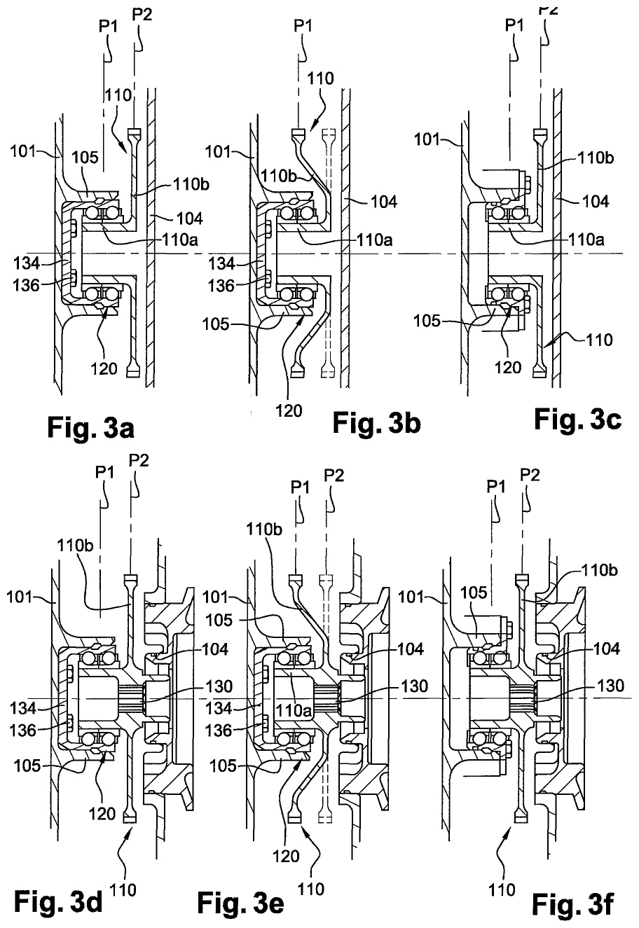

FIGS. 3a to 3f show variants of embodiments of the invention.

The wheels 110 in FIGS. 3a to 3c differ from those 110 in FIG. 2 in particular in that they do not comprises splines. Its body 110a extends axially only on one side of the web 110b, on the side opposite the opening 104 of the housing 101. In contrast, the wheels 110 in FIGS. 3d to 3f include splines 130. However, these are crossed by the above-mentioned plan P2.

In FIGS. 3a, 3c, 3d, and 3f, the webs are flat and contained in the plane P2. On the contrary, in FIGS. 3b and 3e, the webs include an inner peripheral part located in the plane P2 and an outer peripheral part connected to the gear teeth located in the plane P1.

The bearing 120 in FIGS. 3c and 3f is similar to the one in FIG. 2. In FIGS. 3a, 3b, 3d and 3e, the inner ring of the bearing is similar to that of FIG. 2 but its outer ring differs in that it comprises, at its axial end opposite the opening 104, a substantially radial inner annular flange 134 which is applied axially against the bottom of the bore and is secured to it by screws 136.

The arrangement presented above significantly reduces the width of the housing of the power transmission by using a set of gear wheels supported by single bearings.

These bearings absorb axial and radial forces and tilting moments around axes perpendicular to the axis of rotation of the wheel.

The roller bearing shown in the figures is a double row of angular contact balls. According to another embodiment not shown, the bearing is a double row rollers of angular contact.

1. An accessory relay suitable for driving accessory equipment of a gas turbine engine, such as an aircraft engine, comprising a housing and a plurality of gear wheels inside the housing,
the housing including means for fixing the accessory equipment to the housing and for driving it by the gear wheels through openings in the housing,
the wheels each comprising a tubular body and an outer annular web comprising an outer peripheral gear teeth, the wheels being supported in the housing by bearings, at least one of said gear wheels being supported by a single bearing,
characterized in that this bearing comprises a fixed ring radially outer with respect to an axis A of rotation of the wheel and mounted in a bore of the housing, and a movable ring radially inner with respect to the axis A and mounted on the body of the wheel, said bearing being spaced apart axially from a plane perpendicular to the axis A of the wheel and passing through the inner periphery of the web of this wheel.

2. The accessory relay according to claim 1, wherein said bearing is of the rolling element type and for example with double row of balls and angular contact.

3. The accessory relay according to claim 1, wherein said bearing for guiding the wheel is located on the side opposite the opening of the housing aligned with the axis A of this wheel.

4. The accessory relay according to claim 1, wherein the body is provided with inner splines.

5. The accessory relay according to claim 4, wherein said splines are traversed by said plane.

6. The accessory relay according to claim 1, wherein the outer ring includes an outer annular flange applied and fixed via fixing means to the housing.

7. The accessory relay according to claim 1, wherein the outer ring comprises an inner annular flange applied and fixed via fixing means to the housing.

8. The accessory relay according to claim 1, wherein said plane passes through the outer gear teeth of the web.

9. The accessory relay according to claim 1, wherein the web has a non-planar shape.

10. Turbomachinery equipped with an accessory relay according to claim 1.
